(19) United States
(12) Patent Application Publication
(10) Pub. No.: US 2026/0088736 A1
(43) Pub. Date: Mar. 26, 2026

(54) ELECTROSTATIC CHUCK

(71) Applicant: MiCo Ceramics Ltd., Anseong-si (KR)

(72) Inventors: Min-Ho Ji, Anseong-si (KR); Mina Cho, Anseong-si (KR)

(21) Appl. No.: 19/338,064

(22) Filed: Sep. 24, 2025

(30) Foreign Application Priority Data
Sep. 25, 2024 (KR) 10-2024-0129788

(51) Int. Cl. H02N 13/00; B23Q 3/15

(52) U.S. Cl. CPC H02N 13/00; B23Q 3/15

(57) ABSTRACT

Provided is an electrostatic chuck including a ceramic plate having a first surface and a second surface. The ceramic plate includes: a plurality of ceramic layers; a first electrode and a second electrode disposed between the plurality of ceramic layers; a first via and a second via penetrating some of the ceramic layers, the first via being connected to the first electrode, the second via being connected to the second electrode, and one end of the first via and one end of the second via being exposed on the second surface of the ceramic plate; and a conductive silicone pad disposed on the second surface of the ceramic plate and bonded to the one end of the first via and the one end of the second via to electrically connect the first via and the second via.

### CROSS-REFERENCE TO RELATED APPLICATION(S)

This application is based on and claims priority under 35 U.S.C. 119 to Korean Patent Application No. 10-2024-0129788, filed on Sep. 25, 2024, in the Korean Intellectual Property Office, the disclosure of which is herein incorporated by reference in its entirety.

### BACKGROUND OF THE INVENTION

### 1. Field of the Invention

The present disclosure relates to an electrostatic chuck in which electrodes embedded in a ceramic plate are electrically connected using conductive silicone.

### 2. Description of the Prior Art

In general, a semiconductor device or an LCD display device is manufactured by sequentially laminating a plurality of thin film layers, including a dielectric layer and an electrode layer, on a glass substrate, a flexible substrate, or a semiconductor wafer substrate, and then patterning the laminated layers. To support a glass substrate, a flexible substrate, a semiconductor wafer substrate, or the like, and to perform a semiconductor process, a ceramic susceptor such as an electrostatic chuck (ESC) or a ceramic heater is used, and among them, the electrostatic chuck is mainly used in a process of dry-etching thin film layers formed on a substrate.

The electrostatic chuck is a component disposed inside a vacuum chamber of a semiconductor and LCD manufacturing apparatus, on which a substrate such as a semiconductor wafer is placed, and is configured to fix the substrate using electrostatic force and to heat or cool the substrate. A representative example of the electrostatic chuck is a ceramic-type electrostatic chuck.

FIG. 1 is a cross-sectional view illustrating a conventional ceramic-type electrostatic chuck, and FIG. 2 is a bottom view illustrating a lower surface of a conventional ceramic plate.

Referring to FIGS. 1 and 2, an electrostatic chuck 10 includes a ceramic plate 12 and a base 14. The base 14 may be formed of a material such as metal or a metal-ceramic composite (e.g., Al—SiC or Al—TiC). The ceramic plate 12 and the base 14 are bonded by an adhesive such as silicone resin.

The ceramic plate 12, which serves as a portion where a semiconductor wafer or the like is adsorbed, is configured by laminating a plurality of ceramic layers. Inside the ceramic plate 12, electrodes 16 such as a chucking electrode, an RF electrode, and a heating element layer are disposed between the ceramic layers. FIG. 1 illustrates, as an example, an electrostatic chuck including two layers of chucking electrodes 16.

The two layers of chucking electrodes 16 are electrically connected by conductive vias 18 and copper clad laminates (CCLs) 20 to bridge-connect the conductive vias 18. The CCLs 20 in the form of a film serve as members for electrical connection. Each CCL includes a metal layer 22 (e.g., copper) and a polyimide layer 24 for electrically insulating the metal layer 22.

However, since the CCL 20 and the vias 18 are both in a solid state with a predetermined hardness, the CCL 20 and the vias 18 may not be in close contact, thereby causing a fine gap at a contact portion A. In this case, when the temperature of the ceramic plate 12 increases during a process using the electrostatic chuck 10, air bubbles existing in the gap of the contact portion A may expand, causing poor contact between the CCL 20 and the vias 18. In addition, since the ceramic plate 12 is used in an environment having a large temperature variation, such as −100° C. to 200° C., the polyimide of the CCL 20 may expand and contract, resulting in poor contact at the contact portion A.

Furthermore, due to the temperature variation, the ceramic plate 12 and the base 14 may also expand and contract. At this time, since the ceramic plate 12 and the base 14 formed of different materials have different coefficients of thermal expansion, stress is generated due to expansion and contraction. The silicone resin adhesive between the ceramic plate 12 and the base 14 serves to distribute and relieve such stress. However, when the CCL 20 including the metal layer 22 and the polyimide layer 24 is present in a bonding layer between the ceramic plate 12 and the base 14, the distribution of such stress is hindered, thereby causing delamination or cracks of the ceramic plate 12.

### SUMMARY OF THE INVENTION

The present disclosure provides an electrical connection member that may be bonded to be in close contact with a via.

In addition, the present disclosure provides an electrical connection member that may relieve thermal stress between a ceramic plate and a base.

An embodiment of the present disclosure provides an electrostatic chuck including a ceramic plate having a first surface and a second surface. The ceramic plate includes: a plurality of ceramic layers; a first electrode and a second electrode disposed between the plurality of ceramic layers; a first via and a second via penetrating some of the ceramic layers, the first via being connected to the first electrode, the second via being connected to the second electrode, and one end of the first via and one end of the second via being exposed on the second surface of the ceramic plate; and a conductive silicone pad disposed on the second surface of the ceramic plate and bonded to the one end of the first via and the one end of the second via to electrically connect the first via and the second via.

An embodiment of the present disclosure provides the electrostatic chuck, in which the conductive silicone pad is formed by applying liquid conductive silicone.

An embodiment of the present disclosure provides the electrostatic chuck, in which a portion of the conductive silicone is disposed between the one end of the first via and a ceramic layer penetrated by the first via.

An embodiment of the present disclosure provides the electrostatic chuck, in which the conductive silicone includes a conductive filler made of silver (Ag), nickel (Ni), graphite, or a mixture thereof.

An embodiment of the present disclosure provides the electrostatic chuck, in which the conductive silicone pad has a thickness of 50 μm or more and 150 μm or less.

An embodiment of the present disclosure provides the electrostatic chuck, in which the conductive silicone pad has a modulus of elasticity of about 10 MPa at 25° C.

An embodiment of the present disclosure provides the electrostatic chuck, in which the ceramic plate includes a cavity formed to a predetermined depth in the second surface, the one end of the first via and the one end of the second via are exposed in the cavity, and the conductive silicone pad is disposed in the cavity.

An embodiment of the present disclosure provides the electrostatic chuck, in which the cavity has a depth of 50 μm or more and 150 μm or less.

An embodiment of the present disclosure provides an electrostatic chuck including a ceramic plate having a first surface and a second surface. The ceramic plate includes: an electrode disposed inside the ceramic plate; a via penetrating a portion of the ceramic plate and connected to the electrode, one end of the via being exposed to the second surface of the ceramic plate; and a conductive silicone pad disposed on the second surface of the ceramic plate and bonded to the one end of the via, a portion of the conductive silicone pad being disposed between the one end of the via and the ceramic plate penetrated by the via.

According to an embodiment of the present disclosure, a short-circuit of an electrical connection may be prevented between electrodes embedded in a ceramic plate.

In addition, according to an embodiment of the present disclosure, thermal stress between the ceramic plate and a base may be alleviated.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a cross-sectional view illustrating a conventional ceramic type electrostatic chuck;

FIG. 2 is a bottom view illustrating a lower surface of the conventional ceramic plate;

FIG. 3 is a schematic cross-sectional view of an electrostatic chuck according to an embodiment of the present disclosure;

FIG. 4 is a cross-sectional view of a ceramic plate according to an embodiment of the present disclosure before conductive silicone pads are formed;

FIG. 5 is a bottom view of the ceramic plate according to an embodiment of the present disclosure before conductive silicone pads are formed;

FIG. 6 is a cross-sectional view of a ceramic plate according to an embodiment of the present disclosure after conductive silicone pads are formed;

FIG. 7 is a bottom view of the ceramic plate according to an embodiment of the present disclosure after conductive silicones pad are formed;

FIG. 8 is a cross-sectional view of the ceramic plate according to an embodiment of the present disclosure; illustrating a state in which conductive silicone pads are in close contact with vias;

FIG. 9 is a cross-sectional view of a ceramic plate according to another embodiment of the present disclosure before conductive silicone pads are formed; and

FIG. 10 is a cross-sectional view of the ceramic plate according to another embodiment of the present disclosure after conductive silicone pads are formed.

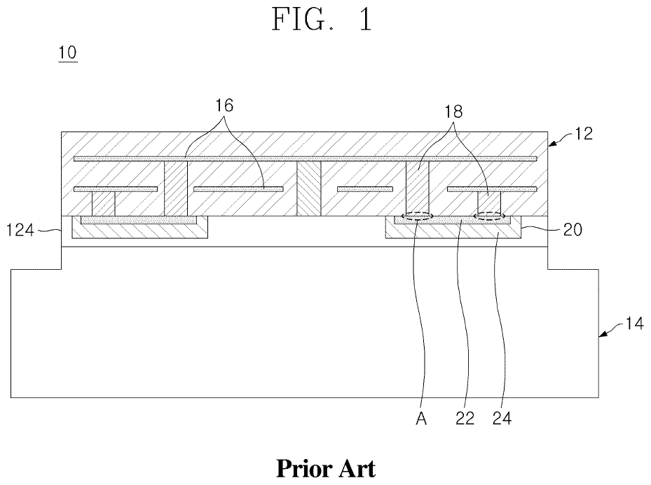

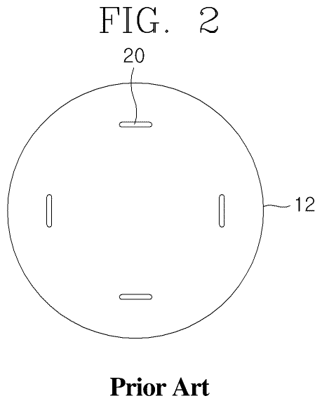

### DETAILED DESCRIPTION OF THE EXEMPLARY EMBODIMENTS

Hereinafter, embodiments disclosed herein will be described in detail with reference to the accompanying drawings. Regardless of drawing numbers, the same or similar elements will be assigned the same reference numerals, and redundant descriptions thereof will be omitted. Hereinafter, in the description of embodiments of the present disclosure, when each layer (film), area, pattern, or structure is described as being formed “on” or “under” a substrate, each layer (film), area, pattern or structure, the terms “on” and “under” are used to cover being formed either “directly” or “indirectly via another layer.”

In addition, the criteria for “on,” “under,” “left,” “right,” “vertical (up-down),” and “horizontal (left-right)” of each layer are described with reference to the drawings. In the drawings, the thickness or size of each layer is exaggerated, omitted, or schematically illustrated for convenience and clarity of description. In addition, the size of each component does not fully reflect the actual size.

As used herein, expressions such as “including,” “comprising” or “consisting of” are intended to indicate any features, numbers, steps, operations, elements, or some thereof or combinations thereof, and should not be construed to exclude the existence or possibility of one or more other features, numbers, steps, operations, elements, or some or combinations thereof, in addition to those described above.

In addition, terms such as “first” and “second” may be used to describe various components, but the components are not limited by the terms, and these terms are only used for the purpose of distinguishing one component from another.

In addition, the term “about” denotes a normal error range for each value that is easily recognized by a person skilled in the art, and may indicate within +0.5% or up to 1% of the specified value. The term “about” may also denote a measurement error caused by limitations of a measurement method.

In addition, in describing the embodiments disclosed herein, when it is determined that detailed descriptions of related known technologies may obscure the gist of the embodiments disclosed herein, the detailed descriptions will be omitted.

It should be understood that the accompanying drawings are only for easy understanding of the embodiments disclosed herein, and that the technical idea disclosed herein is not limited by the accompanying drawings, and includes all changes, equivalents, and substitutes included in the spirit and technical scope of the present disclosure.

Hereinafter, embodiments of the present disclosure will be described in detail with reference to the drawings.

FIG. 3 is a schematic cross-sectional view of an electrostatic chuck according to an embodiment of the present disclosure.

An electrostatic chuck 100 according to an embodiment of the present disclosure is provided in an apparatus for performing a semiconductor process, and is used to support various substrates serving as processing targets, such as a glass substrate, a flexible substrate, and a semiconductor wafer substrate, in a process such as plasma-enhanced chemical vapor deposition. The electrostatic chuck 100 may also be used as a heater for precise temperature control and heat treatment requirements in plasma deposition processes or the like, for precision processes such as miniaturization of wiring in semiconductor devices.

Referring to FIG. 3, the electrostatic chuck 100 according to an embodiment of the present disclosure includes a ceramic plate 112 and a base 114. The ceramic plate 112 has a laminated structure of a plurality of ceramic layers 112a, 112b, and 112c, a plurality of electrodes 116 and 117, vias 118 and 119, and a conductive silicone pad 120.

The ceramic plate 112 is a member configured to adsorb and hold a substrate such as a semiconductor wafer. The ceramic plate 112 has a plate surface (first surface) 113a and a plate rear surface (second surface) 113b, wherein the first surface 113a of the ceramic plate 112 is an adsorption surface that adsorbs a substrate such as a semiconductor wafer. The ceramic plate 112 may be formed by laminating a plurality of ceramic layers 112a, 112b, and 112c in the form of a disk shape having a diameter of about 300 mm and a thickness of about 3 mm.

The ceramic plate 112 is formed of an insulating or dielectric ceramic material, and may be formed of Al₂O₃, Y₂O₃, ZrO₂, AIC, TIN, AlN, TiC, MgO, CaO, CeO₂, TiO₂, BxCy, BN, SiO₂, SiC, YAG, mullite, or AlF₃, or a material in which two or more thereof are used in combination.

The electrodes 116 and 117 are disposed inside the ceramic plate 112. The electrodes 116 and 117 of the ceramic plate 112 may be chucking electrodes, radio frequency (RF) electrodes, and/or heating element layers. The electrodes 116 and 117 may be formed by, for example, a CVD process, a PVD process, a thermal spray coating process, or a screen-printing process.

The chucking electrodes 116 and 117 are configured to generate an electrostatic force for adsorbing and fixing a substrate such as a semiconductor wafer by generating an electric field between the electrodes and the substrate using a DC voltage. The RF electrodes perform an RF grounding function of discharging a current charged by plasma inside a chamber to an external ground during a wafer deposition process. The heating element layer performs a function of heating a substrate, for example, in an etching process of thin film layers formed on the substrate or in a baking process of a photoresist. In an embodiment of the present disclosure, the electrodes 116 and 117 may be chucking electrodes; however, the present disclosure is not limited thereto.

The chucking electrodes 116 and 117 may be configured in two or more layers in order to distribute an electric field more uniformly and to precisely control the holding force of a semiconductor wafer through voltage adjustment between the electrodes. The electrodes 116 and 117 are disposed between a plurality of ceramic layers 112a, 112b, and 112c. The respective electrodes 116 and 117 and ceramic layers 112a, 112b, and 112c may be alternately laminated layer by layer. That is, they may be laminated in the order of the first ceramic layer 112a, the first electrode 116, the second ceramic layer 112b, the second electrode 117, and the third ceramic layer 112c.

The first electrode 116 and the second electrode 117 are disposed on different planes inside the ceramic plate 112. Specifically, the first electrode 116 may be disposed on a plane between the first ceramic layer 112a and the second ceramic layer 112b, and the second electrode 117 may be disposed on a plane between the second ceramic layer 112b and the third ceramic layer 112c. The electrodes 116 and 117 may be made of tungsten (W), molybdenum (Mo), silver (Ag), gold (Au), niobium (Nb), titanium (Ti), or alloys thereof. The electrode layers 116 and 117 embedded in the ceramic plate 112 are supplied with current through an electrode rod 128 disposed in the base 114.

The first electrode 116 and the second electrode 117 are electrically connected by conductive vias 118 and 119. The conductive vias 118 and 119 may have a cylindrical shape having one end and the other end. The first via 118 and the second via 119 penetrate some of the ceramic layers 112a, 112b, and 112c to be connected to the first electrode 116 and the second electrode 117. The first via 118 vertically penetrates the second ceramic layer 112b and the third ceramic layer 112c, and one end of the first via 118 is connected to a lower surface of the first electrode 116. The second via 119 vertically penetrates the third ceramic layer 112c at a position different from the first via 118, and one end of the second via 119 is connected to a lower surface of the second electrode 117. The other end of the first via 118 and the other end of the second via 119 are connected to a conductive silicone pad 120 on the second surface 113b of the ceramic plate. The vias 118 and 119 and the conductive silicone pad 120 will be described in detail separately below.

A base 114 is attached to the second surface 112b of the ceramic plate 112. The base 114 is a member made of a metal or a metal-ceramic composite material (e.g., Al—SiC or Al—TiC) formed in a disk shape, for example, a member made of aluminum or an aluminum alloy. The base 114 may be formed in a multilayer structure including a plurality of metal layers or a plurality of metal-ceramic composite layers. These metal layers or metal-ceramic composite layers may be bonded by a brazing process, a welding process, or a bonding process. The base 114 may be formed in a disk shape having a diameter of 340 mm and a thickness of 32 mm.

An adhesive layer 124 is disposed between the ceramic plate 112 and the base 114 to bond the ceramic plate 112 and the base 114. The adhesive layer 124 may be formed of an adhesive made of silicone resin. At this time, each conductive silicone pad 120 may be embedded in the adhesive layer 124, allowing the adhesive layer 124 to electrically insulate the conductive silicone pad 120 and the metal base 114. Alternatively, the ceramic plate 112 may be fixed on the base 114 using predetermined fixing means. The base 114 and the ceramic plate 112 may be separately manufactured and then bonded, and the structure of the ceramic plate 112 may also be directly formed on an upper surface of the base 114.

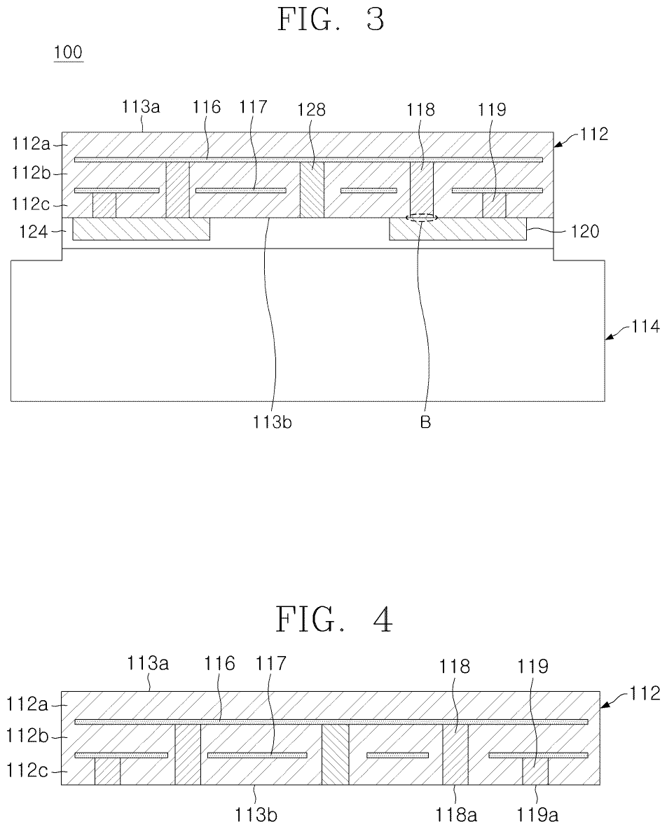

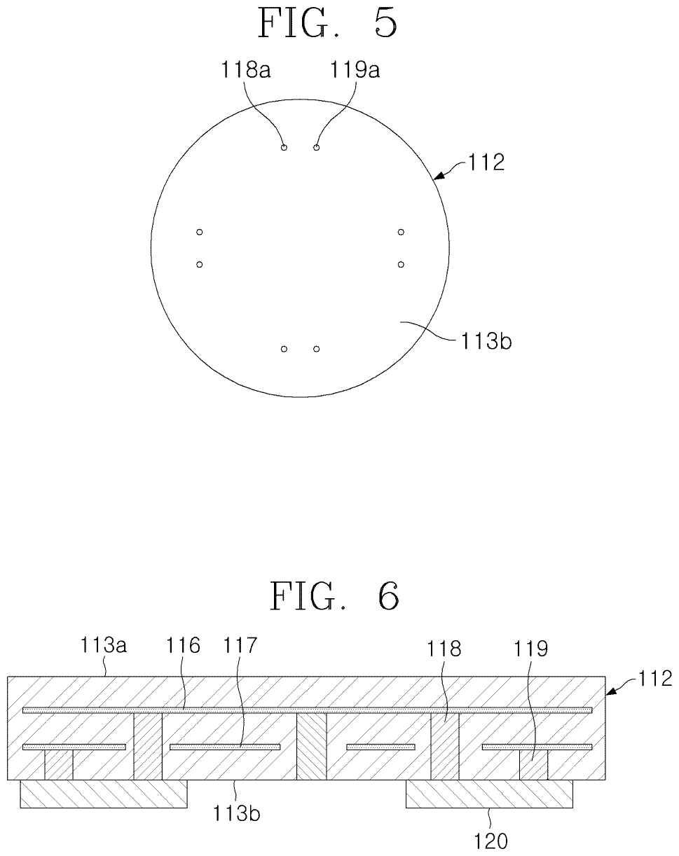

FIG. 4 is a cross-sectional view of a ceramic plate according to an embodiment of the present disclosure before conductive silicone pads are formed, and FIG. 5 is a bottom view of the ceramic plate according to an embodiment of the present disclosure before conductive silicone pads are formed.

Referring to FIGS. 4 and 5, one end of a first via 118 is connected to a lower surface of a first electrode 116, and one end of a second via 119 is connected to a lower surface of a second electrode 117. The other end 118a of the first via and the other end 119a of the second via are exposed on the second surface 113b of the ceramic plate. In an embodiment of the present disclosure, the term “exposed” does not mean only that a specific member is exposed to the atmosphere outside the electrostatic chuck, but is also used to include a state in which a specific member is exposed so as to be visible from the outside and is subsequently covered, coated, or laminated by another member so as to be invisible. Hereinafter, the ceramic plate 112 according to an embodiment of the present disclosure will be described in detail.

The ceramic plate 112 is manufactured by laminating a plurality of ceramic layers 112a, 112b, and 112c and then sintering them. At this time, electrodes 116 and 117 are formed on surfaces of some of the ceramic layers 112a, 112b, and 112c to constitute a laminated structure.

To form conductive vias 118 and 119 for electrical connection between the laminated electrodes 116 and 117, holes are formed in a direction perpendicular to the electrodes 116 and 117. The holes are formed through a third ceramic layer 112c and/or a second ceramic layer 112b from the second surface 113b of the ceramic plate to expose lower surfaces of the first electrode 116 and the second electrode 117. The holes may be formed by a process such as drilling, bead blasting, or etching.

To form the conductive vias 118 and 119, the interiors of the holes may be filled with a conductive material using a conductive metal paste, physical vapor deposition (PVD), chemical vapor deposition (CVD), brazing, or another metal deposition method. One ends 118a and 119a of a first via and a second via formed by being filled with the conductive material may be exposed to the outside on the second surface 113b of the ceramic plate, and may be electrically connected by a conductive silicone pad 120 as described below. At this time, the one ends 118a and 119a of the first via and the second via may be exposed by lapping the second surface 113b of the ceramic plate. Referring to FIG. 5, it can be seen that the one ends 118a and 119a of four pairs of first and second vias are exposed on the second surface 113b of the ceramic plate.

FIG. 6 is a cross-sectional view of the ceramic plate according to an embodiment of the present disclosure after conductive silicone pads are formed, and FIG. 7 is a bottom view of the ceramic plate according to an embodiment of the present disclosure after conductive silicone pads are formed.

Referring to FIGS. 6 and 7, to electrically connect each pair of first and second electrodes 116 and 117, a conductive silicone pad 120 is bonded to the one ends 118a and 119a of each pair of first and second vias on the second surface 113b of the ceramic plate.

The conductive silicone pad 120 is formed by applying liquid conductive silicone, and the conductive silicone includes a conductive filler made of silver (Ag), nickel (Ni), graphite, or a mixture thereof. The conductive silicone applied to be bonded to the one ends 118a and 119a of each pair of first and second vias is cured at a temperature of 100 to 150° C. The conductive silicone pad 120 formed by curing the conductive silicone may be, for example, in a rectangular parallelepiped shape, and may have a thickness of 50 μm or more and 150 μm or less. If the thickness of the conductive silicone pad 120 is less than 50 μm, it may be difficult to form a uniform thickness, and if it exceeds 150 μm, bonding between the ceramic plate 112 and the base 114 may become unstable.

The conductive silicone may be in a liquid state and may include silver (Ag), silicic acid, ethyl ester, siloxane, silicone, and copper oxide. The conductive filler may be silver (Ag), or may be a conductive filler made of silver (Ag), nickel (Ni), graphite, or a mixture thereof. Per 100 parts by weight (wt %) of the conductive silicone, 80 to 100 wt % of silver (Ag), 1 to 5 wt % of silicic acid and/or ethyl ester, 1 to 5 wt % of siloxane and silicone, and 0.1 to 1 wt % of copper oxide may be included. In this case, the siloxane and the silicone may be dimethyl or methyl hydrogen.

The conductive silicone pad 120 may have an elastic modulus of 100 MPa or less, preferably about 10 MPa, at room temperature (25° C.). In contrast, polyimide used in a conventional CCL has a high clastic modulus of 10,000 MPa or more. Accordingly, the conductive silicone pad 120 may relieve thermal stress applied to the ceramic plate 112 due to a temperature difference.

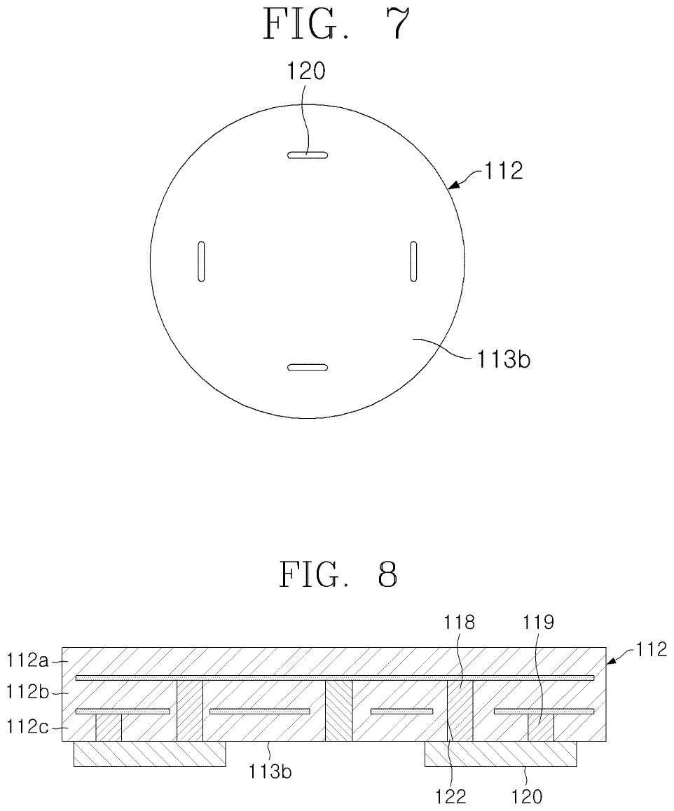

FIG. 8 is a cross-sectional view of a ceramic plate according to an embodiment of the present disclosure, illustrating a state in which each conductive silicone pad is in close contact with vias.

Each conductive silicone pad 120 is formed by applying liquid conductive silicone. Since the liquid conductive silicone is applied in close contact with one ends 118a and 119a of each pair of first and second vias, a gap formed at a contact portion (B in FIG. 3) between the conductive silicone pad 120 and the one ends 118a and 119a of the vias may be eliminated or minimized.

In addition, when a gap 122 exists between the vias 118 and 119 and the ceramic layers 112b and 112c, the applied conductive silicone may fill the gap 122 to remove air bubbles. Specifically, the description is as follows.

As described above, the vias 118 and 119 are formed by filling holes penetrating the ceramic layers 112b and 112c with a conductive material. At this time, a gap 122 or clearance may be formed between the filled conductive material and the ceramic layers 112b and 112c. At this time, the liquid conductive silicone may fill the gap 122 existing between one ends 118a and 119a of the vias and the surrounding ceramic layers.

Table 1 shows a comparison of resistance of an embodiment of the present disclosure with that of a ceramic plate of prior art. In the embodiment of the present disclosure, a first electrode 116 and a second electrode 117 were electrically connected by a conductive silicone pad 120, whereas in the ceramic plate of prior art, a first electrode 16 and a second electrode 17 were electrically connected by a CCL 20.

TABLE 1

| Classification | Resistance at 25° C. | Resistance at 200° C. |
|---|---|---|
| Prior art | 10Ω or less | Not measurable |
| Embodiment of | 10Ω or less | 100Ω or less |
| the present | | |
| disclosure | | |

Resistance between each pair of first and second electrodes was measured at 25° C. and 200° C. using a resistance meter. At 25° C., both the ceramic plates of the embodiment of the present disclosure and the prior art exhibited a resistance value of 10Ω or less.

At 200° C., the embodiment of the present disclosure exhibited a resistance value of 100 Ω or less, whereas in the ceramic plate of prior art, the resistance value was not measurable. That is, in the embodiment of the present disclosure, since the conductive silicone pad 120 is in close contact with the vias 118 and 119 and thermal stress is relieved by the conductive silicone pad 120, electrical connection between the conductive silicone pad 120 and the vias 118 and 119 was maintained. However, in the ceramic plate of prior art, poor contact occurred between the CCL 20 and the vias 16 and 17, and thus the resistance could not be measured.

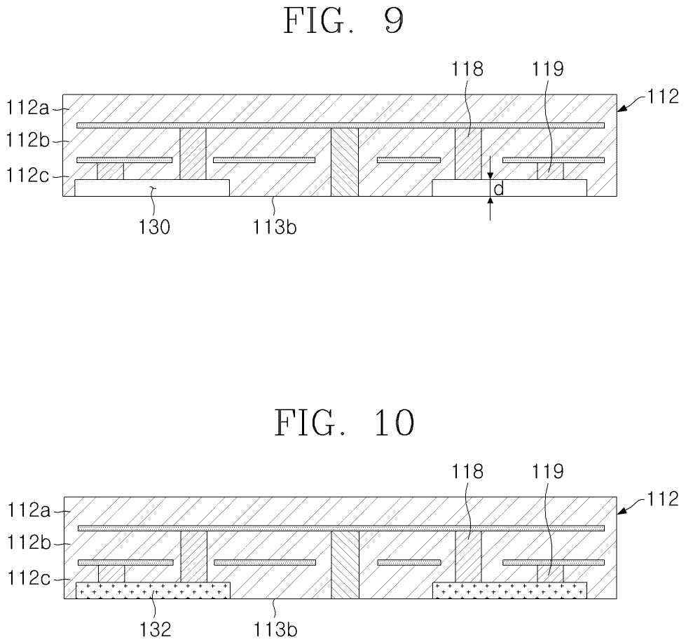

FIG. 9 is a cross-sectional view of a ceramic plate according to another embodiment of the present disclosure before conductive silicone pads are formed, and FIG. 10 is a cross-sectional view of the ceramic plate according to another embodiment of the present disclosure after conductive silicone pads are formed.

Among the descriptions given above, overlapping portions with FIGS. 9 and 10 will be omitted.

Referring to FIGS. 9 and 10, cavities 130 are formed by partially removing the third ceramic layer 112c on the second surface 113b of the ceramic plate. Each cavity 130 is formed in a portion where one ends 118a and 119a of each pair of first and seconds via are exposed. Accordingly, the one ends 118a and 119a of each pair of first and second vias are exposed to the outside by the cavity 130. The cavity 130 may be formed, for example, in a rectangular parallelepiped shape, and may have a depth d of 50 μm or more and 150 μm or less.

The conductive silicone is applied so as to fill the cavity 130. Accordingly, a conductive silicone pad 132 is disposed in the cavity 130. Since the conductive silicone pad 132 is disposed in the cavity 130, the conductive silicone pad 132 may be formed so as not to protrude from the second surface 113b of the ceramic plate. As such, when the second surface 113b of the ceramic plate, which is bonded to the base 114, has a flat shape, bonding between the base 114 and the ceramic plate 112 may be improved.

In the foregoing, the present disclosure has been described based on specific details, such as concrete components, limited embodiments, and drawings, but these have been provided merely to aid a more comprehensive understanding of the present disclosure, and the present disclosure is not limited to the above-described embodiments. Various modifications and alterations may be made without departing from the essential characteristics of the present disclosure by a person ordinarily skilled in the art to which the present disclosure pertains. Therefore, the spirit of the present disclosure should not be limited to the described embodiments, and not only the appended claims, but also all technical ideas that are equivalent or have equivalent modifications to the claims should be construed as being included within the scope of the present disclosure. The above-described individual embodiments may be combined and utilized together as needed.

What is claimed is:

1. An electrostatic chuck comprising a ceramic plate having a first surface and a second surface,
wherein the ceramic plate comprises:
a plurality of ceramic layers;
a first electrode and a second electrode disposed between the plurality of ceramic layers;
a first via and a second via penetrating a portion of the ceramic layers, the first via being connected to the first electrode, the second via being connected to the second electrode, and one end of the first via and one end of the second via being exposed on the second surface of the ceramic plate; and
a conductive silicone pad disposed on the second surface of the ceramic plate and bonded to the one end of the first via and the one end of the second via to electrically connect the first via and the second via.

2. The electrostatic chuck of claim 1, wherein the conductive silicone pad is formed by applying liquid conductive silicone.

3. The electrostatic chuck of claim 2, wherein a portion of the conductive silicone is disposed between the one end of the first via and a ceramic layer penetrated by the first via.

4. The electrostatic chuck of claim 2, wherein the conductive silicone comprises a conductive filler made of silver (Ag), nickel (Ni), graphite, or a mixture thereof.

5. The electrostatic chuck of claim 1, wherein the conductive silicone pad has a thickness of 50 μm or more and 150 μm or less.

6. The electrostatic chuck of claim 1, wherein the conductive silicone pad has a modulus of elasticity of about 10 MPa at 25° C.

7. The electrostatic chuck of claim 1, wherein the ceramic plate comprises a cavity formed to a predetermined depth in the second surface,
wherein the one end of the first via and the one end of the second via are exposed in the cavity, and
wherein the conductive silicone pad is disposed in the cavity.

8. The electrostatic chuck of claim 7, wherein the cavity has a depth of 50 μm or more and 150 μm or less.

9. The electrostatic chuck of claim 1, wherein the first electrode and the second electrode are disposed on different planes between the plurality of ceramic layers.
